(19) United States
(12) Patent Application Publication
(10) Pub. No.: US 2003/0147259 A1
(43) Pub. Date: Aug. 7, 2003

(54) Light emitting flat panel with embedded light guides yielding controlled light extraction for general lighting luminaire

(75) Inventor: Edward Robert Kraft, New York, NY (US)

Correspondence Address: FISH & NEAVE, 1251 AVENUE OF THE AMERICAS, 50TH FLOOR, NEW YORK, NY, 10020-1105, US

(73) Assignee: Opti-Flux Technologies Inc., Las Vegas, NV

(21) Appl. No.: 10/066,010

(22) Filed: Feb. 2, 2002

(51) Int. Cl. G02B 6/42; F21V 8/00

(52) U.S. Cl. 362/576; 362/558; 362/551; 385/129; 385/901

(57) ABSTRACT

A unique solid flat panel lighting emitting luminaire (light panel) has been created that utilizes a light source remote from the luminaire. The light panel luminaire is fed light flux via a light pipe and/or a fiber optic system into one or two edges of the flat panel. The light panel has imbedded irregular tapered tetrahedron shaped light guides that emit light in a uniform controlled fashion over the length of the emitting surface. The subject lighting luminaire provides light without generating heat. The luminaire is unaffected by environmental temperatures and pressures within the boundaries of the base construction materials utilized. The luminaire is specifically designed to provide general or task lighting in any application that would normally use a fluorescent, filament or arc type light bulb without the inherent limitations of usual light sources such as space requirements, access, heat generation, environmental temperature, moisture sensitivity, possible explosive ignition and/or crush or explosion due to hypo or hyper baric pressures.

### REFERENCES CITED

U.S. Patent Documents

| | | | |
|---|---|---|---|
| 4422719 | December, 1983 | Orcutt | 385/123. |
| 4460940 | July, 1984 | Mori | 362/558. |
| 4471412 | September, 1984 | Mori | 362/565. |
| 4822123 | April, 1989 | Mori | 385/31. |
| 4765701 | August, 1988 | Cheslek | 362/560. |
| 5222795 | June, 1993 | Hed | 362/558. |
| 5836669 | November, 1998 | Hed | 362/92. |
| 6210013 | April, 2001 | Bousfeild | 362/92. |

### STATEMENT REGARDING FEDERALLY SPONSORED RESEARCH AND DEVELOPMENT

The subject invention was not funded in any part by the United States Government. All rights are retained by the inventor for his sole use.

### BACKGROUND OF THE INVENTION

Numerous applications of optical fibers bundles to illumination are known. In most cases the fiber bundle is simply used to conduct the light to the remote location and the light is emitted from the open end of these fibers. In some instances, it is desirable to conduct electromagnetic waves along a single or collection of light guides and extract light along a given length of the guide's distal end rather than only at the guide's terminating face. This special need has been recognized in the prior art and numerous approaches to the extraction of light at intervals from optical light guides or optical fibers have been proposed. Each of these proposals, however, has its specific shortcomings making the application impractical or limited to only a few situations.

For instance, Orcutt in U.S. Pat. No. 4,422,719, proposes the extraction of light from a light guide by enclosing the wave guide within a transparent sleeve having an index of refraction greater than the index of refraction of the wave guide and embedding within the sleeve light-reflecting powders, or by providing other discontinuities such as cuts or air bubbles within the fiber core. This approach has a number of shortcomings. First, the light extraction rate along the guide declines monotonically (and quite rapidly) from the proximal end to the distal end. The higher index of refraction of the cladding causes conversion of core modes (light propagation mode) to cladding modes to occur at the proximal end or the composite guide, thus sharply depleting the beam intensity as the light traverses the full length of the guide. Furthermore, the use of particles and bubbles suspended within the cladding causes excessive absorption of the light in the transmitting medium (particularly the cladding itself. Orcutt attempts to overcome the lack of light extraction control by including in the core refracting discontinuities or “light extraction” cuts through the cladding to the core and spacing these as a function of the distance from the light source. This approach is difficult to implement and furthermore, creates a series of discrete light sources along the guide and does not allow for continuous light extraction.

Mori (U.S. Pat. Nos. 4,460,940, 4,471,412 and 4,822,123) uses discrete light diffusing elements on a light transmission element to extract light from said light guide. In U.S. Pat. No. 4,460,940, Mori uses convex or concave diffusing elements to extract light of a specific wavelength, and a set of discrete elements with increasing density (but constant thickness) toward the distal end of the transmitting medium to extract light (presumably all wavelengths) from the transmitting element.

In U.S. Pat. Nos. 4,471,412 and 4,822,123, Mori uses discrete light outlets on a light conducting member. In the former patent he uses discrete diffusing elements without consideration to their quantitative light extraction capabilities while in U.S. Pat. No. 4,822,123 he uses light scattering discrete elements and simply increases their number as he approaches the distal end of the light conductor. The disadvantages of Mori's light extraction systems include discontinuity of the light sources in that the appearance of the device includes a plurality of concentrated light sources, and the great difficulty in correctly spacing and sizing the extraction elements to provide for controlled light extraction from the light guide. Furthermore, the manufacturing and assembly of the devices of Mori is awkward and costly.

Cheslek U.S. Pat. No. 4,765,701 also uses discrete elements to extract light from an optical fiber in conjunction with a panel. Cheslek uses angular recesses and does not provide for means to control quantitatively the light extraction, and as a result, the illumination from the downstream (distal) recesses is progressively lower.

Hed U.S. Pat. No. 5,222,795 proposed a curve linear tapering of the cross sectional area of a fiber optic and abrading or painting the flattened surface. Hed in U.S. Pat. No. 5,836,669 then proposed the application or elongated triangular reflective stripes on to a plastic plate. The tapering of the fiber optics provided a one way illumination with a substantial amount of light that could not be extracted from the distal end of the tapered fiber perpendicular to the emitting plate face. The painted triangle method does not allow enough emitting area to make the light emitted practical for general illumination. The light injection end in both these applications do not provide enough distance for an even light flux and would cause a bright spot at the injection end. This condition on Hed's flat panel application is overcome by making the injection end part of the triangle very narrow and starting the installation of that triangle far from the emitting edge of the panel and thus further limiting the emitting surface.

Bousfeild U.S. Pat. No. 6,210,013, proposes a matrix of dots with increased diameters as they lay distal to the light injecting edge on a flat panel. This method is again limited by the actual area of reflectance.

The prior art as described is a two dimensional light propagation over a flat panel and thus the light output is limited by the actual area of the reflecting coating or treatment. The Light Emitting Panel herein described uses three dimensional groves that have a surface area on two sides that is increased as it runs distal from the injection edge of the panel. The amount of light emitted is determined by the surface area and reflectance of the grooves.

### FIELD OF THE INVENTION

My present invention relates to the controlled light extraction from light guides cast, imbedded or machined into base plastic or glass panels that are fed light through one or more edges from a remote source. The plastic or glass panel have a high measure of light transmittance better than 91% and a refractive index of 1.49 to 1.51. Light is emitted from the face of the panel refracted from the machined surface of the light guides within the panel. The surface area of the light guides increases as they lay further from the light input end. The interior emitting surface of the light guides are treated to cause light refraction on their surface. High reflectance paint is applied to the interior sides of the grooves. Light is either emitted directly from the light guide surface through the face of the panel or from the reflected light from the back of the panel then through the face of the panel.

A tapered light guide injector that has the shape and size of the light flux transporting light pipe on one end and the shape and size of the light panel on the other end provides an area where light flux is arranged by total internal reflection to preserve the light flux etendue and distribute the light evenly across the light input edge of the light emitting zone.

The subject invention was created to replace fluorescent lighting luminairs or applications with a remote light source device to overcome the space requirements, heat production, maintenance requirements, and application limitations of common light sources.

### OBJECTS OF THE INVENTION

The principal object of the invention is to provide a method of and means for extracting light from an edge lit panel in a controlled manner so that drawbacks of earlier illuminating systems using other light guides are avoided.

Another object is to provide light guides within a panel from which light can be extracted in a continuous manner by the refraction or by the diffused reflection of a controlled proportion of the light traversing the optical transmitting medium.

It is a further object of the luminaire device to provide a method to efficiently extract light in a continuous and at a predetermined rate from optical other light guides.

It is yet another object of the luminaire device to provide linear light sources having a predetermined relative luminosity along their length.

It is still another object of the luminaire device to provide such light sources where the luminosity along their length can be constant.

It is a particularly important object of the invention to provide such light extraction systems from which substantially all the light entering the extractor's proximal end is extracted along the extractor's extraction zone.

A further object of the instant invention is to provide a light extractor from which a predetermined residual portion of the light entering the proximal end of the extraction zone is allowed to be emitted at the extractor distal end while the balance of the light is extracted along the light emitting zone.

### SUMMARY OF THE INVENTION

These objects and others which will become apparent hereinafter are attained, in accordance with the present invention in a method of illuminating an area which comprises the steps of:

(a) providing at least one elongated light guide within a panel parallel with a remote light source emission. Said light guide is installed in such a manner by casting machining or cutting the panel. The light guide has a progressive internal surface that is refractive in nature.

(b) modifying a portion of the surface over an extraction zone of the light guide to impart a generally irregular tetrahedron shape to the zone extending continuously from a narrow small cross sectional end to a wider and larger cross sectional end thereof and so that light traveling through the panel in a propagation direction form the narrow end to the wide end will emanate in an emanation direction transversely to the propagation direction, the zone narrowing in width in a spreading direction transversely to the propagation direction and to the emanation direction whereby an area exposed to the light emanating from the light guide is illuminated continuously along the length of the light emitting zone;

(c) and injecting light into the light guide ahead of said narrow end so that the light propagates in said propagation direction whereby the area is illuminated.

Thus, I extract light in an extraction zone of the light guide in a controlled manner by treating a portion of the light guide surface in the extraction zone of the panel so as to convert a portion of the light panel along the extraction zone into a light guide that has at least two surfaces that are treated in a manner to refract and reflect light perpendicular to the emitting face of the panel.

A surface of the core light guide exposed over the light-extraction zone can be rendered diffusively light emissive by abrading the surface, coating the surface and/or chemically treating the surface.

### BRIEF DESCRIPTION OF THE DRAWINGS

The above and other objects, features and advantages of the present invention will become more readily apparent from the following description, reference being made to the accompanying drawing in which:

FIG. 1 is a diagrammatic perspective view showing a clear polymethylmethacrylate (PMMA) Light Panel with the location of multiple emitting light guides and the tapered light guide injection area;

FIG. 1-A is a diagrammatic perspective view showing of the Light Panel with multiple emitting light guides cut into the back of the panel and the reflective layer of RTV Silicone and mirror.

FIG. 2 is a larger cross section of the light guides cut into the light panel with the reflective paint layer applied into the grooves, the RTV Silicone layer and the mirror layer.

FIG. 2-A shows the relative depth of the groove cut from the small cross sectional area at the proximal end of the panel and a larger cross sectional depth at the distal end of the panel.

FIG. 3 is a perspective view showing the geometric shape of the light guide within the light panel.

FIG. 4 is a diagrammatic drawing showing the configuration of a remote light source attached to several light panels with light pipes.

### DETAILED DESCRIPTION OF THE INVENTION

My present invention relates to the controlled light extraction from light guides cast, imbedded or machined into base plastic or glass panels that are fed light from a remote source. Light is emitted from a clear panel from the surface of the light guides within the panel. The surface area of the light guides increases as they lay further from the light input end. The interior emitting surface of the light guides are treated to cause light refraction on their surface. Light is either emitted directly from the light guide surface through the face of the panel or from the reflected light from the back of the panel that is covered by RTV Silicone with a refractive index of 1.4.

A tapered light guide injection area that has the shape and size of the light flux transporting light pipe on one end and the shape and size of the light panel on the other end provides an area where light flux is arranged by total internal reflection to preserve the light flux etendue.

The subject invention was created to replace fluorescent lighting luminairs or applications with a remote light source device to overcome the space requirements, heat production, maintenance requirements, and application limitations of common light sources.

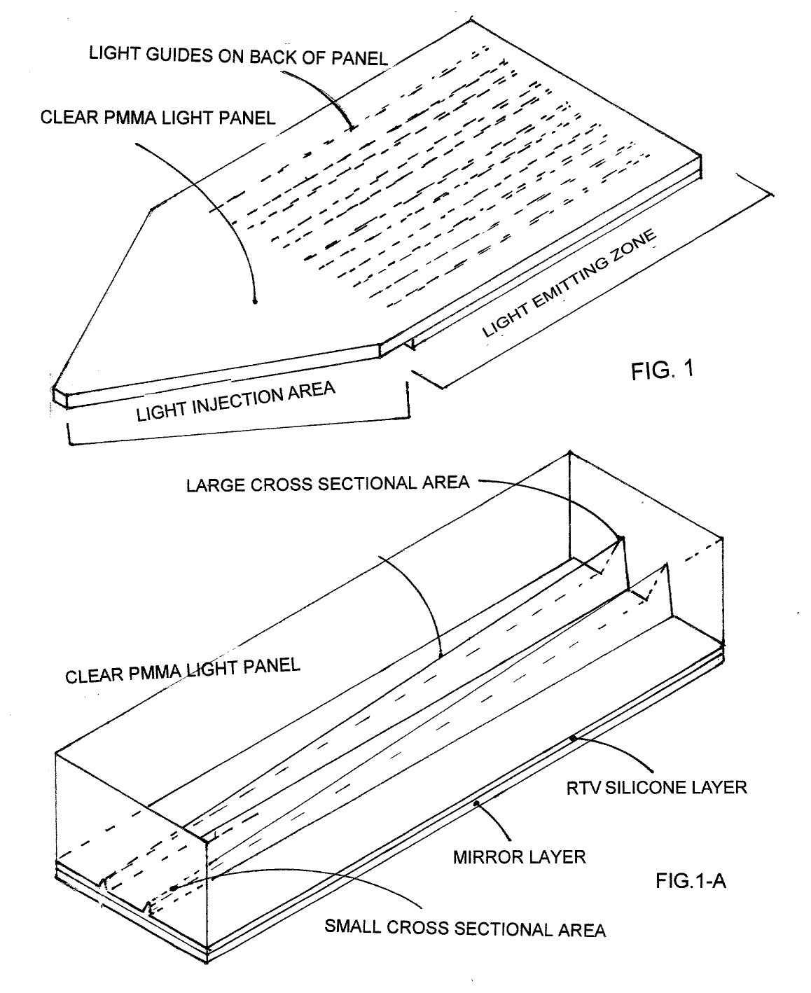

FIG. 1 shows two general areas of the light emitting panel; the tapered light guide section and the light emitting zone. Light entering the tapered light guide injection can be from any light source and can be conducted by any fiber optic or light pipe system.

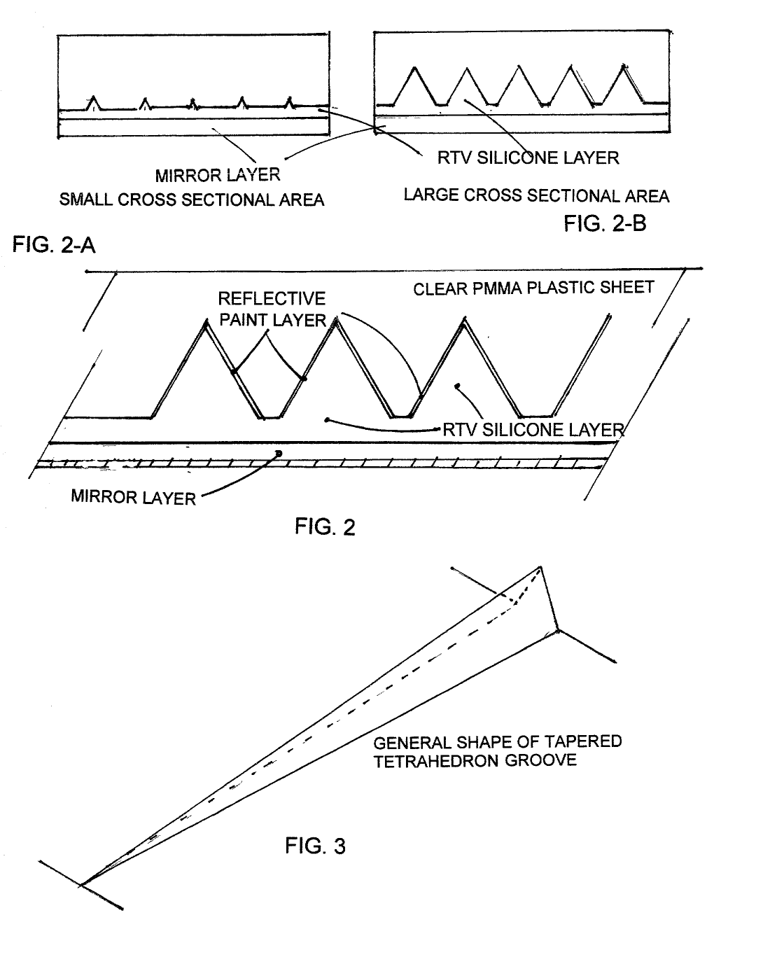

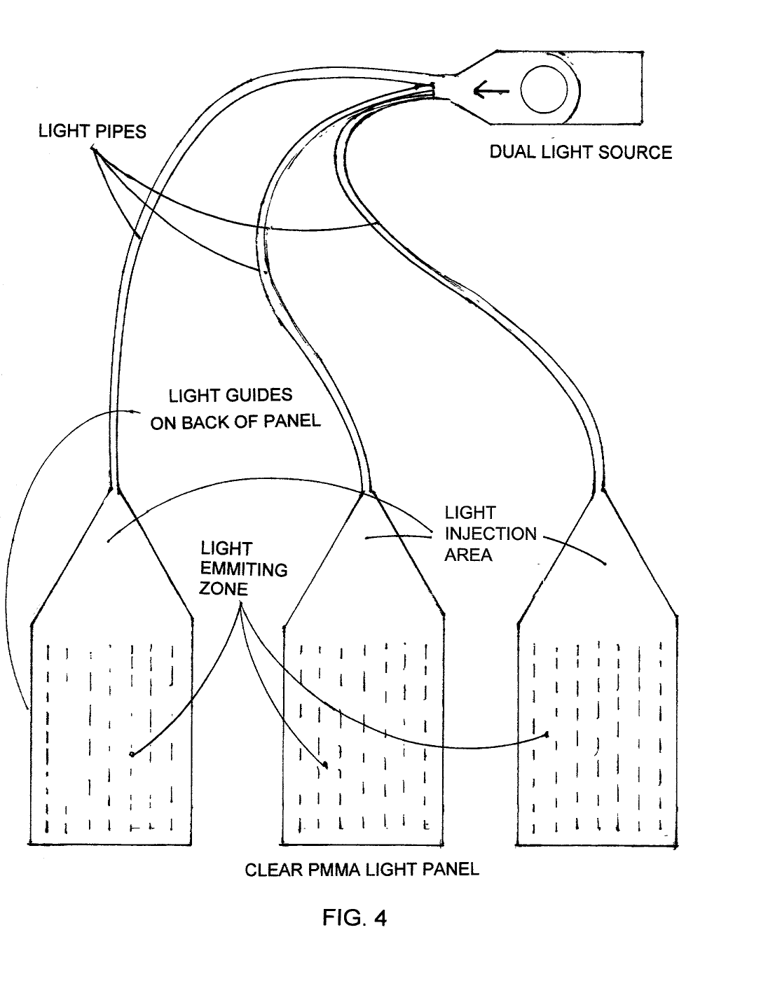

Light flux enters the tapered light guide area from fiber optics or a light pipe and as such is highly organized as a flux rather than a wide spread beam. The tapered light guide provides an area where the light flux can be evenly averaged and distributed across the proximal end of the emitting area of the light emitting panel by internal reflection. Once the light flux enters the light emitting area, it encounters areas of refraction and reflection from light guides that are cut or cast into the light panel on one side (FIGS. 2, 2-A, 2C). These refraction/reflection light guides have an increased surface area as they lay more distal to the light flux injection area (FIG. 2-C).

As the light flux travels parallel to the light refraction/reflection side and the emitting side the refraction/reflection light guide areas disrupt the light flux organization and cause skew rays to be emitted opposite the refraction/reflection side of the light panel. The light flux loses intensity as it travels though the panel and is emitted from the panel. The increased surface area of the refraction/reflection areas (FIG. 2-C) compensates for the light intensity loss as it travels through and emitted from the panel and thus light is emitted uniformly from the panel from the injection end to the distal end.

Excess light that is not emitted from the panel and travels to the distal perpendicular edge is reflected back into the panel.

While I have described a number of embodiments here, it will be understood that all of the features specific to one embodiment can be used, to the extent compatible, in any other and that the invention also embraces all new and unobvious features individually and in combination within the spirit and scope of the appended claims.

It should be obvious to those skilled in the art that in practicing this invention, and designing extraction system with available intensity along the extraction zone, it is preferred to position the zones of lower luminosity closer to the proximal end and the zones of higher luminosity near the distal end of the extraction zone, when the direction of light propagation is from the proximal to the distal end. In this way as the light flux loses intensity the area of reflectance grows larger.

I claim:

1. A remote illumination system has been created comprising:
a light source;
an optical light pipe for transporting light flux from said light source;
a tapered light guide that couples the light flux form the transporting light pipe to a light emitting luminaire;
a lighting luminaire for delivering and emitting light from said light source and light flux transportation system to a desired region, the luminaire being optically connected to said light source.

2. A lighting luminaire device as stated in claim 1 has been created by casting or machining at least one irregular tapered tetrahedron light guide into a flat rectangular plastic or glass panel.
(a) That the surface of the embedded light guide is abraded, etched and/or treated to affect light refraction on the bounty between the base panel material and the imbedded light guide. That the light guide (s) has a progressively larger cross sectional area and increasing surface area as it lays more distal to the light injection edge. That light flux is organized and injected into the emitting region of the luminaire via a flux organizational light guide section into at least one edge of the light panel and causing the light flux entering the emitting region to be organized and evenly distributed across the light injection edge of the luminaire emitted in a uniform fashion across the light panel:
(b) providing at least one elongated imbedded tapered light guide having a surface so structured with respect to the base panel thereof as to enable said light guide to transmit light along the light guide while said periphery prevents substantial emanation of light from said light guide in a direction transverse to said light guide;
(c) modifying a portion of said periphery over an extraction zone of said light guide to impart a generally tapered irregular tetrahedron shape to said zone extending continuously from a cross sectionally small end to a cross sectionally large end thereof and so that light traveling through said core in a propagation direction from said small end to said large end will emanate in an emanation direction transversely to said propagation direction, said zone narrowing in width in a spreading direction transversely to said propagation direction and to said emanation direction whereby an area exposed to said light emanating from said light guide is illuminated continuously along said length of said zone; and
(d) injecting light into said light guide ahead of said narrow end so that the light propagates in said propagation direction whereby said area is illuminated.

3. The method defined in claim 2 whereby said light guide is machined or cast into the base panel material of plastic or glass and said light guide is generally an irregular tetrahedron having an increased surface area as it lays distally to the light injection edge.
(a) The surface of the embedded light guide may have additional smaller surfaces within the general irregular tetrahedron shape to provide more surface area of light emission.
(b) The method defined in claim 2, further comprising the step of rendering a surface of said light guide which is exposed over said zone diffusively light emissive.
(c) The method defined in claim 2 wherein said surface is rendered diffusively light emissive by abrading said surface.
(d) The method defined in claim 2 wherein said surface is rendered diffusively light emissive by coating said surface.
(e) The method defined in claim 2 wherein said surface is rendered diffusively light emissive by chemically treating said surface.

4. A device that provides illumination from a remote light source via a transporting light pipe by injecting light flux into at least one edge of the light emitting panel from the edge that is perpendicular the small end of the embedded light guides.
(a) That the light flux is injected parallel to the light guides.
(b) The light flux is injected via a tapered light pipe area optically attached or part of the base panel material. That this tapered light injection area is of sufficient length to preserve the light source radiant flux density over the area of the light injecting edge of the light panel. The tapered light pipe injector provides angular averaging of the input light flux and provides a method of traversing the input light flux from the transporting light pipe while maintaining the etendue from the transporting light pipe.
(c) The tapered light pipe injector is an integral part of the light panel system as it provides a coupling area to provide a uniform light flux from a light supply pipe of one shape and size attached to a light source and the light panel of another shape and size.
(d) The tapered light pipe injector has one end that is the shape and size of the light flux transporting light pipe and the other end that is the shape of the light panel.
(e) The tapered light pipe injector area organizes the light flux in a uniform manner across its coupling area and eliminates high light intensity areas (“hot spots”) at the light input end of the light panel.
(f) The tapered light pipe injector may be bent over a radius of 10 times its ½ thickness or greater.

5. The luminaire is specifically designed to provide general or task lighting in any application that would normally use a fluorescent, filament or arc type light bulb without the inherent limitations of usual light sources such as space requirements, heat generation, environmental temperature, moisture sensitivity, possible explosive ignition and/or crush or explosion due to hypo or hyper baric pressures.
(a) The ambient operating moisture, chemical and/or temperatures of the luminairs are only limited by the properties of the base plastic or glass materials used.
(b) No heat is generated from the luminaire and can be used in explosive environments.
(c) The luminaire is fashioned from a solid plastic or glass panel and is unaffected by operating pressures. The luminaire could operate in extreme hypo and hyper baric conditions without exploding or crushing.
(d) The luminaire can be fashioned to fit into existing or new “T” grid drop ceilings for use in residential or commercial office lighting.
(e) The luminaire could be permanently sealed into place in clean room air plenums and do not require removal for servicing as there are serviceable parts.
(f) The luminaire has no replaceable parts and is ideally suited for areas that are inaccessible or where access would create a problem such as back lit billboards. The light emitting surface can be manufactured in very large sections and would be ideally suited for any large exterior back lit signage. The emitting surface could be etched, painted, silk screened or laminated with normal signage materials.

6. The luminaire can be surface mounted or hung.

7. The light source is remote from the subject luminaire.
(a) The heat generated from the light source could be discarded to lower air conditioning requirements or recycled to provide heat for other uses.
(b) Access to the interior of the light emitting panel is not required for maintenance.
(c) The light emitting panel can be used in explosive atmospheres.
(d) The light panel can be used in caustic atmospheres.
(e) The light emitting panel is unaffected by atmospheric or ambient pressure or pressure changes.

8. The light panel service temperature is only defined by the materials that it is composed of.
(a) Using alternate base materials with the same inherent optical properties can extend the service temperatures to the extremes found in outer space.
